(19) United States
(12) Patent Application Publication
(10) Pub. No.: US 2012/0003498 A1
(43) Pub. Date: Jan. 5, 2012

(54) COPPER-ZINC ALLOY ELECTROPLATING BATH AND METHOD OF PLATING USING SAME

(75) Inventor: Yukiko Wada, Kodaira-shi (JP)

(73) Assignee: BRIDGESTONE CORPORATION, Chuo-ku, Tokyo (JP)

(21) Appl. No.: 13/254,661

(22) PCT Filed: Mar. 4, 2010
(86) PCT No.: PCT/JP2010/053524

§ 371 Date: Sep. 2, 2011

(30) Foreign Application Priority Data
Mar. 4, 2009 (JP) 2009-050438

(51) Int. Cl. C25D 3/56; B32B 15/01

(52) U.S. Cl. 428/615; 205/240

(57) ABSTRACT

Provided is a copper-zinc alloy electroplating bath which can form a copper-zinc alloy plating coating having an improved throwing property and a plating method using the same.

Also provided is a copper-zinc alloy electroplating bath containing, as an additive, at least one selected from the group consisting of the compounds represented by the following formulae (I) to (III):

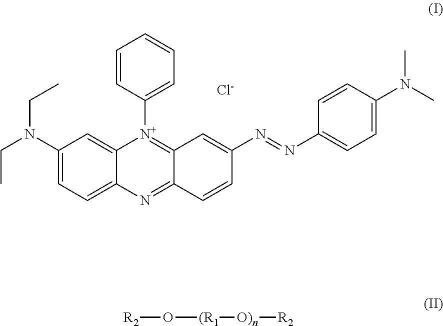

(wherein R₁ represents a lower alkylene group, R₂ represents H or a lower alkyl group, and the weight-average molecular weight is 10³ to 10⁵); and

Na—SO₃—(CH₂)₃—S—S—(CH₂)₃—SO₃—Na (III)

These additives can be used alone, and two or more of these can be used in combination.

### TECHNICAL FIELD

The present invention relates to a copper-zinc alloy electroplating bath and a plating method using the same, more particularly to a copper-zinc alloy electroplating bath which can form a copper-zinc alloy plating coating having an improved throwing property and a plating method using the same.

### BACKGROUND ART

At present, copper-zinc alloy plating is widely used industrially as decorative plating to give a brass colored metallic luster and color tone to metal products, plastic products and ceramic products and the like. However, since a conventional plating bath contains a large amount of cyanide, its toxicity has become a big problem, and the burden of disposal of cyanide-containing waste has been large.

As means for solving these problems, a number of methods for copper-zinc alloy plating wherein no cyanide is used have been reported up to now. For example, sequential plating is a practical method for application of brass plating to a product to be plated, and in such a method, a copper-plated layer and a zinc-plated layer are sequentially plated on the surface of the product to be plated by electrodeposition, followed by a thermal diffusion step. In the case of sequential brass plating, a pyrophosphate copper plating solution and an acidic zinc sulfate plating solution are usually used (e.g., Patent Document 1).

On the other hand, as a method for simultaneous plating with copper-zinc, a cyanide-free copper-zinc alloy electroplating bath has also been reported, and a plating bath using a tartrate bath or a potassium pyrophosphate bath supplemented with histidine as a complexing agent has been proposed (e.g., Patent Document 2).

### RELATED ART DOCUMENTS

### Patent Documents

Patent Document 1: Japanese Unexamined Patent Application Publication No. 5-98496
Patent Document 2: Japanese Examined Patent Application Publication No. 3-20478

### SUMMARY OF THE INVENTION

### Problems to be Solved by the Invention

Although it is known that the above-described cyanide-free pyrophosphate bath gives a good throwing property in the case of copper plating, a sufficient throwing property cannot have been obtained in the case of copper-zinc alloy plating. That is, there has been a problem in that although a copper-zinc alloy plating coating can be formed, since burnt deposits are likely to be generated on the plating coating, and the throwing property is unfavorable (because ununiformity is likely to be generated), plating is not applied to a minute area.

Accordingly, an object of the present invention is to provide a copper-zinc alloy electroplating bath which can form a copper-zinc alloy plating coating having an improved throwing property and a plating method using the same.

### Means for Solving the Problems

In order to solve the above-described problems, the present inventor intensively studied to discover that, by adding an additive which is widely used for acidic electrolytic copper plating, the throwing property is improved even in the case of pyrophosphate plating bath, which can reduce the surface roughness, thereby completing the present invention.

That is, the copper-zinc alloy electroplating bath of the present invention is characterized by containing, as an additive, at least one selected from the group consisting of the compounds represented by the following formulae (I) to (III):

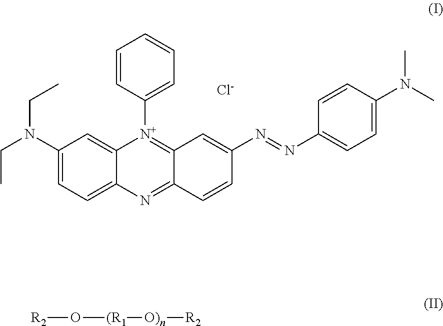

(wherein R₁ represents a lower alkylene group, R₂ represents H or a lower alkyl group, and the weight-average molecular weight is 10³ to 10⁵); and

Na—SO₃—(CH₂)₃—S—S—(CH₂)₃—SO₃—Na (III)

In the copper-zinc alloy electroplating bath of the present invention, compounds represented by the formula (I), the formula (II) and/or the formula (III) are preferably contained as additives; halogen ion is preferably contained; further, a copper salt, a zinc salt, an alkali metal pyrophosphate, and at least one material selected from amino acids and salts thereof are preferably contained; and still further, at least one selected from an alkali metal hydroxide salt and an alkaline-earth metal hydroxide salt is preferably contained. In the copper-zinc alloy electroplating bath of the present invention, the amount of the additives added is preferably 1 to 5000 mg/L; further, the pH is preferably in the range of 8 to 14; still further, the amino acid is preferably histidine; and still further, nitrate ion is preferably contained.

The copper-zinc alloy electroplating method of the present invention is characterized in that, by using the copper-zinc alloy electroplating bath of the present invention, an electroplating process is carried out at a cathode electric current density in the range of 0.5 A/dm² to 14 A/dm².

Further, a metal cord of the present invention is characterized by being composed of a metal wire on which a plating process is applied using the copper-zinc alloy electroplating method of the present invention.

### Effects of the Invention

By the present invention, a copper-zinc alloy electroplating bath which can form a copper-zinc alloy plating coating having an improved throwing property and a plating method using the same can be provided, as well as a metal cord in which the surface roughness parameter of the copper-zinc alloy plating coating is reduced can be obtained.

### MODE FOR CARRYING OUT THE INVENTION

Preferred modes of the present invention will now be described in detail.

It is important that the copper-zinc alloy electroplating bath of the present invention contains, as an additive, at least one of the compounds represented by the following formulae (I) to (III):

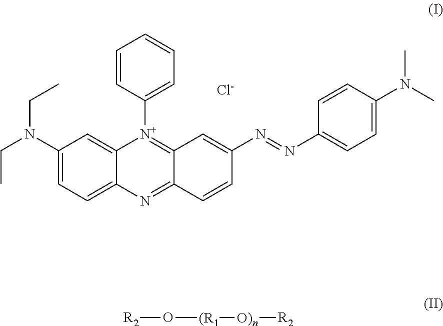

(wherein R₁ is a lower alkylene group, R₂ is H or a lower alkyl group, and the weight-average molecular weight is 10³ to 10⁵) (hereinafter, also referred to as “polyoxy alkylene derivatives”)

Na—SO₃—(CH₂)₃—S—S—(CH₂)₃—SO₃—Na (III)

(bis(3-sulfopropyl) disulfide disodium, hereinafter, also referred to as “SPS”). By using JGB, polyoxyalkylene derivatives or SPS as an additive for a copper-zinc alloy electroplating bath, the throwing property of a copper-zinc alloy plating coating can be improved. As the polyoxyalkylene derivatives, for example, polyethylene glycol can be suitably used. The weight-average molecular weight of polyethylene glycol is preferably 3000 to 8000.

Such additives may be used alone or two or more of these can be used in combination. For example, JGB, and polyoxyalkylene derivatives and/or SPS can be used simultaneously.

The amount of the above-described additives added is suitably 1 to 5000 mg/L respectively. It is because, when the amount of the additives added is less than 1 mg/L, the effect of addition of the additives cannot be obtained; on the other hand, when the amount of the additives added is more than 5000 mg/L, the throwing property of the copper-zinc alloy plating coating becomes worse on the contrary. More suitably, in the case of JGB, the amount thereof is in a range of 100 to 1000 mg/L; and in the cases of polyoxyalkylene derivatives and SPS, the amount thereof is in a range of 10 to 1000 mg/L.

When polyoxyalkylene derivatives are used as an additive, halogen ion is preferably contained. By the addition of halogen ion, the effect of the present invention can be favorably obtained. As the halogen ion, chloride ion is preferred and the amount thereof added is 5 mg/L to 500 mg/L.

The above-described additives can be suitably applied to a copper-zinc alloy electroplating bath containing a copper salt, a zinc salt, an alkali metal pyrophosphate, and at least one material selected from amino acids and salts thereof.

As the copper salt, any known copper ion sources for a plating bath can be employed, and examples thereof can include copper pyrophosphate, copper sulfate, copper chloride, copper sulfamate, copper acetate, basic copper carbonate, copper bromide, copper formate, copper hydroxide, copper oxide, copper phosphate, copper silicofluoride, copper stearate and copper citrate. These may be used alone, or two or more of these may be used.

As the zinc salt, any known zinc ion sources for a plating bath can be employed, and examples thereof can include zinc pyrophosphate, zinc sulfate, zinc chloride, zinc sulfamate, zinc oxide, zinc acetate, zinc bromide, basic zinc carbonate, zinc oxalate, zinc phosphate, zinc silicofluoride, zinc stearate and zinc lactate. These may be used alone, or two or more of these may be used.

The sum amount of copper and zinc dissolved in the plating bath is preferably in the range of 0.03 to 0.30 mol/L. When the sum amount is less than 0.03 mol/L, precipitation of copper predominates and it becomes difficult to obtain a favorable copper-zinc alloy plating coating. On the other hand, when the sum amount is more than 0.30 mol/L, gloss on the surface of the plating coating cannot be obtained.

Any known alkali metal pyrophosphates can be employed, and examples thereof include potassium pyrophosphate and sodium pyrophosphate.

Further, the concentration of the amino acid or salts thereof which are used in the copper-zinc alloy electroplating bath of the present invention is 0.08 mol/L to 0.22 mol/L, and preferably 0.10 mol/L to 0.13 mol/L. When the concentration of the amino acid and salts thereof is lower than 0.08 mol/L, in the case using a high current density, a uniform copper-zinc alloy electroplating coating cannot be obtained. On the other hand, when the concentration of the amino acid or salts thereof is higher than 0.22 mol/L, the content of copper in the alloy plating coating becomes high, and also, uniform copper-zinc alloy plating coating having a desired composition cannot be obtained.

Any known amino acids can be employed, and examples thereof include a-amino acids such as glycine, alanine, glutamic acid, aspartic acid, threonine, serine, proline, tryptophan and histidine, or hydrochlorides and sodium salts thereof. Histidine is preferred. These are used alone, or two or more of these may be used.

Further, it is also preferred that the copper-zinc alloy electroplating bath of the present invention contain a nitrate ion. It is thought that the reactions represented by the following formulae (IV), (V):

2H⁺+2e⁻→H₂ (IV)

NO₃⁻+H₂O+2e⁻→NO₂⁻+2OH⁻ (V)

are taking place. In the condition without a nitrate ion, since the reaction represented by the formula (IV) proceeds competitively with precipitation of the metal, hydrogen gas is generated and attached to the surface of the electrode. As a result, provision of the metal ion to the area is inhibited, the surface roughness of the plating layer on which a plating process is applied in a predetermined time increases, the inside of the plating layer becomes sparse, and thus a uniform plating coating cannot be obtained. On the other hand, when a nitrate ion is present in the plating bath, the reaction represented by the formula (V) predominating over the reaction represented by the formula (IV) proceeds with precipitation of the metal. Here, since the product of the reaction (V) is NO₂⁻, it is immediately detached from the surface of the electrode and does not prevent precipitation of the metal. Thus, it is thought that the surface of the plated object on which a plating process is applied in a predetermined time is smooth, and the obtained plating coating is dense. In the present invention, nitrates used are not particularly limited and any known nitrates can be employed.

The concentration of the nitrate ion in the plating bath of the present invention is preferably 0.001 to 0.050 mol/L. When the concentration of the nitrate ion is higher than 0.050 mol/L, a large amount of current is consumed by reduction reaction of nitrate ion and a current used for the formation of a plating coating is reduced, so that the productivity of the plating coating is reduced. On the other hand, the concentration of nitrate ion is lower than 0.001 mol/L, inhibition of the generation of hydrogen is not sufficient, so that the effect of addition of nitrate ion cannot be favorably obtained.

Further, in the copper-zinc alloy electroplating bath of the present invention, the pH is preferably 8 to 14. When the pH is lower than 8, a glossy uniform copper-zinc alloy coating cannot be obtained. On the other hand, when the pH is higher than 14, the currency efficiency is reduced. In order to adjust the pH of the copper-zinc alloy electroplating bath of the present invention, alkali metal hydroxides such as sodium hydroxide and potassium hydroxide, and alkaline-earth metal hydroxides such as calcium hydroxide are preferably employed. Potassium hydroxide is preferred.

Next, the copper-zinc alloy electroplating method of the present invention will be described.

In the plating method using the copper-zinc alloy electroplating bath of the present invention, the copper-zinc alloy electroplating bath of the present invention is used to carry out a plating process at a wide range of current density of 0.5 A/dm² to 14 A/dm². When a copper-zinc alloy electroplating is applied by using the copper-zinc alloy electroplating bath of the present invention, a usual electroplating method can be adopted. For example, the electroplating may be carried out at a bath temperature of 20 to 40° C., without stirring, or with a mechanical stirrer or air agitation. In this case, any anode which is used for a usual copper-zinc alloy electroplating can be employed. By using the copper-zinc alloy electroplating bath of the present invention, a plating process can be carried out at a wide range of current density of 0.5 A/dm² to 14 A/dm², and a glossy uniform copper-zinc alloy plating coating can be formed with more productivity than by the conventional process.

Before carrying out the electroplating process, usual pretreatments such as buffing, delipidation and dilute acid dip can be applied on a body to be plated by a conventional method, and alternatively, a base plating such as a gloss nickel plating can also be applied. After plating, usual operations such as washing with water, washing with hot water and drying may be carried out. Further, dip in a dilute dichromic acid solution, a clear coat or the like may be carried out as required.

In the present invention, the body to be plated is not particularly limited, and usually any body on which a copper-zinc alloy electroplating coating is applied can be employed. Examples thereof include metal products such as a metal wire used for a steel cord for reinforcing rubber articles, plastic products and ceramic products.

The present invention will now be described in detail by way of Examples.

According to the compositions of the copper-zinc alloy electroplating baths each shown in the following Tables 1 to 3, copper-zinc alloy electroplating baths of Examples 1 to 10 and Comparative Examples 1 to 3 were prepared. Immediately after preparing the plating baths, a copper-zinc alloy electroplating process was carried out according to the plating conditions in the below-described Tables. As the body to be plated, an iron wire was used. The obtained copper-zinc alloy plating coatings were analyzed regarding the amount of plating attached and the composition of the alloy. The surface roughness of the obtained copper-zinc alloy plating coating, and the durability of adherence between the obtained wire and a rubber were evaluated. The evaluation method is described below. By using an iron plate as a body to be plated, the range of cathode electric current density in which a glossy uniform plating coating can be obtained was confirmed by changing only the cathode electric current density in the same conditions. The obtained results are shown in the same Table in combination.

(Surface Roughness)

The surface roughness of the copper-zinc alloy plating coating was observed by using a laser microscope, and roughness parameters Ra, Rv and Rz were obtained. The obtained results are shown in the same Table in combination.

<Ra>

Ra was calculated according to the average roughness (Ra) on the center line on the surface of the plated object:

$$Ra = \frac{1}{L} {\int }_{0}^{L} \vert f ( x ) \vert d x$$

The calculation of the average roughness on the center line was performed by taking out, from a roughness curve, a portion having a measurement length L in the center line direction; setting the center line of the portion taken out an x-axis, the direction of longitudinal magnification a y-axis, and the roughness curve y=f(x), and representing the value of Ra given by the above formula in micrometer unit (um).

<Rv>

The calculation of the maximum depth (Rv) was performed by taking out, from a roughness curve, a portion having a measurement length L in the center line direction and representing the maximum value Zv of the trough depth of the roughness curve in micrometer unit (um).

<Rz>

The calculation of the surface roughness in maximum height (Rz) was performed by taking out, from a roughness curve, a portion having a measurement length L in the center line direction and representing the sum of the maximum value Zp of the peak height and the maximum value Zv of the trough depth of the roughness curve in micrometer unit (um).

(Durability)

Iron wires on which a copper-zinc alloy plating process was applied were parallelly arranged at an interval of 12.5 mm, coated with a rubber composition from the upper side and from the underside and vulcanized at 160° C. for 20 minutes to produce a rubber-iron wire complex having a width of 12.5 mm. The obtained product was degraded at 70° C. and at a relative humidity of 100% for two, three and four days. Then, according to ASTMD-2229, the iron wire was pulled out from each of the samples and the coverage of rubber attached to the iron wire was represented in terms of 0 to 100% to be employed as indices of durability. The larger the value the higher the durability, which is preferred. The results are shown in the Tables 1 to 3 in combination.

TABLE 1

| | | | | | | | Comparative |
|---|---|---|---|---|---|---|---|
| | | | Example 1 | Example 2 | Example 3 | Example 4 | Example 1 |
| mass ratio of | copper sulfate | | 25.1 | 25.1 | 25.1 | 25.1 | 25.1 |
| bath (g/L) | zinc sulfate | | 20.2 | 20.2 | 20.2 | 20.2 | 20.2 |
| | potassium pyrophosphate | | 347.7 | 347.7 | 347.7 | 347.7 | 347.7 |
| | histidine | | 15.67 | 15.67 | 15.67 | 15.67 | 15.67 |
| | JGB | | 0.1 | 0.1 | 0.1 | 0.1 | 0 |
| | PEG*¹ | | 0 | 0 | 0 | 0 | 0 |
| | HCl | | 0 | 0 | 0 | 0 | 0 |
| | SPS | | 0 | 0 | 0 | 0 | 0 |
| | potassium hydroxide | | added for pH | added for pH | added for pH | added for pH | added for pH |
| | | | adjustment | adjustment | adjustment | adjustment | adjustment |
| | potassium nitrate | | 0 | 0 | 0.08 | 0.45 | 0 |
| plating | pH | | 11.0 | 11.0 | 11.0 | 11.0 | 11.0 |
| condition | bath temperature (° C.) | | 30 | 30 | 30 | 30 | 30 |
| | cathode electric current | | 1.2 | 6.0 | 1.2 | 6.0 | 1.2 |
| | density (A/dm²) | | | | | | |
| | plating time (sec) | | 300 | 120 | 300 | 120 | 300 |
| evaluation | amount of plating | | 0.18 | 0.28 | 0.15 | 0.22 | 0.20 |
| | attached (mg/cm²) | | | | | | |
| | composition (Cu %) | | 62.6 | 62.4 | 62.2 | 61.8 | 61.7 |
| | surface | Ra | 0.133 | 0.126 | 0.123 | 0.138 | 0.533 |
| | roughness | Rv | 0.342 | 0.353 | 0.339 | 0.371 | 1.139 |
| | (μm) | Rz | 0.705 | 0.657 | 0.678 | 0.602 | 2.355 |
| | gloss uniform electric current | | 0.5~10 | 0.5~10 | 0.5~14 | 0.5~14 | 0.5~10 |
| | density range*² (A/dm²) | | | | | | |
| | durability (%) | 2^{nd} day | 100 | 100 | 100 | 100 | 100 |
| | | 3^{rd} day | 40 | 35 | 40 | 40 | 20 |
| | | 4^{th} day | 10 | 10 | 10 | 10 | 5 |

*¹polyethylene glycol (weight-average molecular weight: 5000)
*²the range of an electric current in which a glossy uniform copper-zinc alloy plating coating can be obtained

TABLE 2

| | | | Comparative | | | |
|---|---|---|---|---|---|---|
| | | | Example 2 | Example 5 | Example 6 | Example 7 |
| mass ratio of | copper sulfate | | 25.1 | 25.1 | 25.1 | 25.1 |
| bath (g/L) | zinc sulfate | | 20.2 | 20.2 | 20.2 | 20.2 |
| | potassium pyrophosphate | | 347.7 | 347.7 | 347.7 | 347.7 |
| | histidine | | 15.67 | 15.67 | 15.67 | 15.67 |
| | JGB | | 0 | 0.1 | 0.1 | 0.5 |
| | PEG*¹ | | 0 | 0.3 | 0.3 | 0.6 |
| | HCl | | 0 | 0.05 | 0.05 | 0.1 |
| | SPS | | 0 | 0.01 | 0.01 | 0.05 |
| | potassium hydroxide | | added for pH | added for pH | added for pH | added for pH |
| | | | adjustment | adjustment | adjustment | adjustment |
| | potassium nitrate | | 0 | 0 | 0 | 0 |
| plating | pH | | 11.0 | 11.0 | 11.0 | 11.0 |
| condition | bath temperature (° C.) | | 30 | 30 | 30 | 30 |
| | cathode electric current | | 6.0 | 1.0 | 6.0 | 1.0 |
| | density (A/dm²) | | | | | |
| | plating time (sec) | | 120 | 300 | 120 | 300 |
| evaluation | amount of plating | | 0.31 | 0.23 | 0.26 | 0.21 |
| | attached (mg/cm²) | | | | | |
| | composition (Cu %) | | 61.8 | 60.4 | 60.0 | 60.6 |
| | surface | Ra | 0.606 | 0.158 | 0.132 | 0.118 |
| | roughness | Rv | 1.381 | 0.369 | 0.351 | 0.334 |
| | (μm) | Rz | 3.486 | 0.680 | 0.608 | 0.672 |
| | gloss uniform electric current | | 0.5~10 | 0.5~10 | 0.5~10 | 0.5~10 |
| | density range*² (A/dm²) | | | | | |
| | durability (%) | 2^{nd} day | 100 | 100 | 100 | 100 |
| | | 3^{rd} day | 10 | 40 | 20 | 35 |
| | | 4^{th} day | 0 | 10 | 5 | 10 |

*¹polyethylene glycol (weight-average molecular weight: 5000)
*²the range of an electric current in which a glossy uniform copper-zinc alloy plating coating can be obtained

TABLE 3

| | | | | | | Comparative |
|---|---|---|---|---|---|---|
| | | | Example 8 | Example 9 | Example 10 | Example 3 |
| mass ratio of | copper sulfate | | 25.1 | 25.1 | 25.1 | 25.1 |
| bath (g/L) | zinc sulfate | | 20.2 | 20.2 | 20.2 | 20.2 |
| | potassium pyrophosphate | | 347.7 | 347.7 | 347.7 | 347.7 |
| | histidine | | 15.67 | 15.67 | 15.67 | 15.67 |
| | JGB | | 0.5 | 0 | 0 | 0 |
| | PEG*¹ | | 0.6 | 0.3 | 0 | 0 |
| | HCl | | 0.1 | 0 | 0 | 0 |
| | SPS | | 0.05 | 0 | 0.01 | 0 |
| | potassium hydroxide | | added for pH | added for pH | added for pH | added for pH |
| | | | adjustment | adjustment | adjustment | adjustment |
| | potassium nitrate | | 0 | 0 | 0 | 0 |
| plating | pH | | 11.0 | 11.0 | 11.0 | 11.0 |
| condition | bath temperature (° C.) | | 30 | 30 | 30 | 30 |
| | cathode electric current | | 6.0 | 1.0 | 1.0 | 1.0 |
| | density (A/dm²) | | | | | |
| | plating time (sec) | | 120 | 300 | 300 | 300 |
| evaluation | amount of plating | | 0.28 | 0.20 | 0.19 | 0.20 |
| | attached (mg/cm²) | | | | | |
| | composition (Cu %) | | 61.8 | 62.4 | 62.3 | 60.1 |
| | surface | Ra | 0.120 | 0.162 | 0.168 | 0.447 |
| | roughness | Rv | 0.325 | 0.392 | 0.415 | 1.268 |
| | (μm) | Rz | 0.639 | 0.671 | 0.693 | 2.142 |
| | gloss uniform electric current | | 0.5~10 | 0.5~10 | 0.5~10 | 0.5~10 |
| | density range*² (A/dm²) | | | | | |
| | durability (%) | 2^{nd} day | 100 | 100 | 100 | 100 |
| | | 3^{rd} day | 20 | 40 | 40 | 20 |
| | | 4^{th} day | 5 | 15 | 20 | 5 |

*¹polyethylene glycol (weight-average molecular weight: 5000)
*²the range of an electric current in which a glossy uniform copper-zinc alloy plating coating can be obtained

From the results in the Tables 1 to 3, it is found that, by the copper-zinc alloy electroplating bath of the present invention, a copper-zinc alloy electroplating coating having a good throwing property can be obtained. It is also found that, in the range of the electric current density of 0.5 A/dm² to 14 A/dm², a glossy uniform copper-zinc alloy plating coating can be obtained. It is also found that, in the case of using the copper-zinc alloy electroplating bath of the present invention, the adherence between the obtained plated body and a rubber is excellent due to the good throwing property of the plating coating.

1. A copper-zinc alloy electroplating which contains, as an additive, at least one selected from the group consisting of the compounds represented by the following formulae (I) to (III): 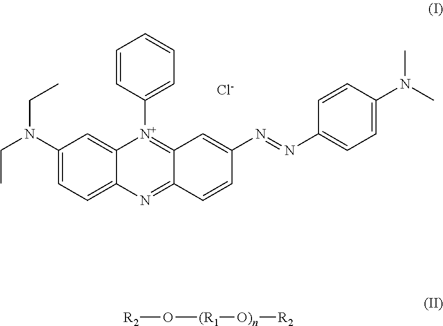
(wherein R₁ represents a lower alkylene group, R₂ represents H or a lower alkyl group, and the weight-average molecular weight is 10³ to 10⁵); and
Na—SO₃—(CH₂)₃—S—S—(CH₂)₃—SO₃—Na (III)

2. The copper-zinc alloy electroplating bath according to claim 1, wherein compounds represented by the formula (I), the formula (II) and/or the formula (III) are contained as additives.

3. The copper-zinc alloy electroplating bath according to claim 1, wherein the compound represented by the formula (II) and a halogen ion are contained.

4. The copper-zinc alloy electroplating bath according to claim 1, wherein a copper salt, a zinc salt, an alkali metal pyrophosphate, and at least one material selected from amino acids and salts thereof are contained.

5. The copper-zinc alloy electroplating bath according to claim 1, wherein at least one selected from an alkali metal hydroxide salt and an alkaline-earth metal hydroxide salt is contained.

6. The copper-zinc alloy electroplating bath according to claim 1, wherein the amount of the additives added is 1 to 5000 mg/L.

7. The copper-zinc alloy electroplating bath according to claim 1, wherein the pH is in a range of 8 to 14.

8. The copper-zinc alloy electroplating bath according to claim 4, wherein the amino acid is histidine.

9. The copper-zinc alloy electroplating bath according to claim 1, wherein a nitrate ion is contained.

10. A copper-zinc alloy electroplating method, characterized in that, by using the copper-zinc alloy electroplating bath according to claim 1, an electroplating process is carried out at a cathode electric current density in the range of 0.5 A/dm² to 14 A/dm².

11. A metal cord characterized by being composed of a metal wire on which a plating process is applied using the copper-zinc alloy electroplating method according to claim 10.
